(19) United States
(12) Patent Application Publication
(10) Pub. No.: US 2025/0252955 A1
(43) Pub. Date: Aug. 7, 2025

(54) SPEECH RECOGNITION METHOD AND APPARATUS

(71) Applicant: ALIBABA INNOVATION PRIVATE LIMITED

(72) Inventors: Yuqin LIN, Hangzhou (CN); Shiliang ZHANG, Hangzhou (CN); Zhifu GAO, Hangzhou (CN)

(21) Appl. No.: 18/856,011

(22) PCT Filed: Apr. 10, 2023
(86) PCT No.: PCT/CN2023/087200

§ 371 Date: Oct. 10, 2024

(30) Foreign Application Priority Data
Apr. 13, 2022 (CN) 202210383886.7

(51) Int. Cl. G10L 15/22; G06F 40/279; G10L 15/02; G10L 25/30

(52) U.S. Cl. CPC G10L 15/22; G06F 40/279; G10L 15/02; G10L 25/30

(57) ABSTRACT

Embodiments of this specification provide a speech recognition method and apparatus. The speech recognition method includes: obtaining speech data to be recognized; extracting a speech feature in the speech data to obtain a first speech feature; performing accent feature recognition on the first speech feature to obtain a second speech feature carrying an accent feature; and recognizing first speech text content corresponding to the speech data based on the second speech feature. The accuracy and efficiency of speech recognition can be improved.

### CROSS-REFERENCE TO RELATED APPLICATIONS

This application is a National Stage of International Application No. PCT/CN2023/087200, filed on Apr. 10, 2023, which claims priority to Chinese Patent Application No. 202210383886.7, filed to China National Intellectual Property Administration on Apr. 13, 2022 and entitled “SPEECH RECOGNITION METHOD AND APPARATUS”, both of which are hereby incorporated by reference in their entireties.

### TECHNICAL FIELD

Embodiments of this specification relate to the field of computer technologies and, in particular, to a speech recognition method.

### BACKGROUND

An accent refers to a voice with personal or local language features. In daily life, when people from one region speak a language of another region, they tend to maintain their habitual way of pronunciation, so different accents may come out. Take Chinese as an example. There are eight major dialects for Chinese, namely Mandarin, Wu Chinese, Xiang Chinese, Gan Chinese, Hakka, Southern Hokkien, Northern Hokkien and Cantonese. Among them, Mandarin is the dialect closest to standard Chinese, and the other dialects differ significantly from standard Chinese in both acoustic pronunciation and linguistic performance. Since most Mandarin users master Mandarin as a second language, their Mandarin pronunciation is inevitably strongly affected by the pronunciation of their native dialects, resulting in the phenomena of inaccurate pronunciation, mispronunciation, etc., leading to reduced speech recognition performance of machines or smart devices. Therefore, an effective solution is urgently needed to solve the above problems.

### SUMMARY

In view of this, embodiments of this specification provide a speech recognition method. One or more embodiments of this specification also relate to a speech recognition apparatus, a computing device, a computer-readable storage medium and a computer program, so as to solve the technical deficiencies existing in the prior art.

According to a first aspect of embodiments of this specification, a speech recognition method is provided, including:
obtaining speech data to be recognized;
extracting a speech feature in the speech data to obtain a first speech feature;
performing accent feature recognition on the first speech feature to obtain a second speech feature carrying an accent feature; and
recognizing, based on the second speech feature, first speech text content corresponding to the speech data.

In an implementation, before extracting the speech feature in the speech data to obtain the first speech feature, the method further includes:
obtaining a pre-trained speech recognition model, where the speech recognition model includes an encoding layer, a multi-expert network layer, and a decoding layer;
extracting the speech feature in the speech data to obtain the first speech feature includes:
inputting the speech data into the encoding layer to extract the speech feature to obtain the first speech feature;
performing the accent feature recognition on the first speech feature to obtain the second speech feature carrying the accent feature includes:
inputting the first speech feature into the multi-expert network layer for the accent feature recognition to obtain the second speech feature carrying the accent feature;
recognizing, based on the second speech feature, the first speech text content corresponding to the speech data includes:
inputting the second speech feature carrying the accent feature into the decoding layer to perform recognition on the speech data to obtain the first speech text content.

In an implementation, before obtaining the pre-trained speech recognition model, the method further includes:
obtaining an accent speech training sample set and a preset to-be-trained model, where the accent speech training sample set contains multiple accent speech samples;
extracting any accent speech sample from the multiple accent speech samples and inputting the accent speech sample into the to-be-trained model to obtain an output result;
determining a loss value according to the output result, and adjusting a model parameter of the to-be-trained model according to the loss value, continuing to perform the step of extracting any accent speech sample from the multiple accent speech samples, and determining the to-be-trained model after training as the speech recognition model when a first preset training stop condition is met.

In an implementation, after determining the to-be-trained model after training as the speech recognition model when the first preset training stop condition is met, the method further includes:
obtaining an accent speech correction sample set, where the accent speech correction sample set contains multiple accent speech correction samples each carrying an accent speech label;
extracting any accent speech correction sample from the accent speech correction sample set and inputting the accent speech correction sample into the speech recognition model to obtain a predicted recognition result;
determining a difference value according to the predicted recognition result and the accent speech label carried by the accent speech correction sample; and
adjusting the model parameter of the speech recognition model according to the difference value, continuing to perform the step of extracting any accent speech correction sample from the accent speech correction sample set, and obtaining a target speech recognition model when a second preset training stop condition is met.

In an implementation, the to-be-trained model includes a sampling layer, an encoding layer, a multi-expert network layer, and a decoding layer;
inputting the accent speech sample into the to-be-trained model to obtain the output result includes:
   inputting the accent speech sample into the sampling layer for sampling processing to obtain a sampling result for the accent speech sample;
   inputting the sampling result into the encoding layer for speech feature extraction to obtain a first predicted speech feature; and
   inputting the first predicted speech feature into the multi-expert network layer for accent feature recognition to obtain a second predicted speech feature carrying an accent feature;
determining the loss value according to the output result, and adjusting the model parameter of the to-be-trained model according to the loss value includes:
   calculating the loss value according to the sampling result, the first predicted speech feature and the second predicted speech feature and adjusting the model parameter of the to-be-trained model according to the loss value.

In an implementation, calculating the loss value according to the sampling result, the first predicted speech feature and the second predicted speech feature and adjusting the model parameter of the to-be-trained model according to the loss value includes:
calculating a first sub-loss value according to the second predicted speech feature and the sampling result, and calculating a second sub-loss value according to the first predicted speech feature and the second predicted speech feature; and
adjusting a first model parameter of the encoding layer based on the first sub-loss value, and adjusting a second model parameter of the multi-expert network layer based on the second sub-loss value.

In an implementation, before inputting the first predicted speech feature into the multi-expert network layer for accent feature recognition to obtain the second predicted speech feature carrying the accent feature, the method further includes:
obtaining an accent embedding feature of the accent speech sample;
inputting the first predicted speech feature into the multi-expert network layer for accent feature recognition to obtain the second predicted speech feature carrying the accent feature includes:
splicing the accent embedding feature to the first predicted speech feature, inputting the first predicted speech feature spliced with the accent embedding feature into the multi-expert network layer for accent feature recognition to obtain the second predicted speech feature carrying the accent feature.

In an implementation, before inputting the first predicted speech feature into the multi-expert network layer for accent feature recognition to obtain the second predicted speech feature carrying the accent feature, the method further includes:
obtaining an accent label of the accent speech sample;
inputting the first predicted speech feature into the multi-expert network layer for accent feature recognition to obtain the second predicted speech feature carrying the accent feature includes:
inputting the accent label and the first predicted speech feature into the multi-expert network layer for accent feature recognition to obtain the second predicted speech feature carrying the accent feature;
adjusting the second model parameter of the multi-expert network layer based on the second sub-loss value includes:
determining a to-be-adjusted model parameter of the multi-expert network layer according to the accent label; and
adjusting the to-be-adjusted model parameter based on the second sub-loss value.

In an implementation, inputting the accent speech correction sample into the speech recognition model to obtain the predicted recognition result includes:
obtaining an accent identifier of the accent speech correction sample;
inputting the accent speech correction sample into the encoding layer for speech feature extraction to obtain a third predicted speech feature;
inputting the third predicted speech feature and the accent identifier into the multi-expert network layer for accent feature recognition to obtain a fourth predicted speech feature carrying an accent feature; and
inputting the fourth predicted speech feature carrying the accent feature into the decoding layer to perform recognition to obtain the predicted recognition result.

In an implementation, the speech data is an audio segment of an audio to be recognized;
recognizing, based on the second speech feature, the first speech text content corresponding to the speech data includes:
   obtaining second speech text content of adjacent speech data, where the adjacent speech data is an audio segment adjacent to the speech data in the audio to be recognized; and
   recognizing the first speech text content corresponding to the speech data according to the second speech feature, the accent feature and the second speech text content.

In an implementation, extracting the speech feature in the speech data to obtain the first speech feature includes:
performing sampling processing on the speech data to obtain a sampling result for the speech data; and
performing speech feature extraction on the sampling result for the speech data to obtain the first speech feature.

According to a second aspect of the embodiments of this specification, a speech recognition apparatus is provided, including:
a first obtaining module configured to obtain speech data to be recognized;
an extraction module configured to extract a speech feature in the speech data to obtain a first speech feature;
a first recognition module configured to perform accent feature recognition on the first speech feature to obtain a second speech feature carrying an accent feature; and
a second recognition module configured to recognize, based on the second speech feature, first speech text content corresponding to the speech data.

According to a third aspect of the embodiments of this specification, a computing device is provided, including:
a memory and a processor;
the memory is configured to store computer-executable instructions, and the processor is configured to execute the computer-executable instructions; when the computer-executable instructions are executed by the processor, the steps of the above speech recognition method are implemented.

According to a fourth aspect of the embodiments of this specification, a computer-readable storage medium is provided, which stores computer-executable instructions. When the instructions are executed by a processor, the steps of the above speech recognition method are implemented.

According to a fifth aspect of the embodiments of this specification, a computer program is provided. When the computer program is executed in a computer, the computer is caused to perform the steps of the above speech recognition method.

A speech recognition method provided in an embodiment of this specification includes obtaining speech data to be recognized; extracting a speech feature in the speech data to obtain a first speech feature; performing accent feature recognition on the first speech feature to obtain a second speech feature carrying an accent feature; and recognizing, based on the second speech feature, first speech text content corresponding to the speech data. By performing the accent feature recognition on the first speech feature, the second speech feature carrying the accent feature can be obtained, and then during the speech text content recognition, the first speech text content corresponding to the speech data can be recognized based on the second speech feature carrying the accent feature, improving the accuracy of the first speech text content, that is, improving the accuracy and efficiency of speech recognition.

### BRIEF DESCRIPTION OF DRAWINGS

FIG. 1 is a flowchart of a speech recognition method provided by an embodiment of this specification.

FIG. 2 is a schematic structural diagram of a to-be-trained model in a speech recognition method provided by an embodiment of this specification.

FIG. 3 is a schematic structural diagram of a multi-expert network layer in a speech recognition method provided by an embodiment of this specification.

FIG. 4 is a schematic structural diagram of a sampling layer and an encoding layer in a speech recognition method provided by an embodiment of this specification.

FIG. 5 is a schematic diagram of a structure for adjusting a model parameter of a multi-expert network layer in a speech recognition method provided by an embodiment of this specification.

FIG. 6 is a schematic diagram of a structure for adjusting a model parameter of a multi-expert network layer in another speech recognition method provided by an embodiment of this specification.

FIG. 7 is a schematic diagram of a structure for adjusting a model parameter of a multi-expert network layer in yet another speech recognition method provided by an embodiment of this specification.

FIG. 8 is a schematic structural diagram of an accent classifier in a speech recognition method provided by an embodiment of this specification.

FIG. 9 is a flowchart of a processing procedure of a speech recognition method provided by an embodiment of this specification.

FIG. 10 is a schematic structural diagram of a speech recognition apparatus provided by an embodiment of this specification.

FIG. 11 is a structural block diagram of a computing device provided by an embodiment of this specification.

### DESCRIPTION OF EMBODIMENTS

In the following description, numerous specific details are set forth to facilitate a thorough understanding of this specification. However, this specification can be implemented in many other ways different from those described here. Those skilled in the art can make similar extensions without violating the connotation of this specification. Therefore, this specification is not limited by the specific implementations disclosed below.

The terminologies used in one or more embodiments of this specification are only for the purpose of describing particular embodiments and is not intended to limit the one or more embodiments of this specification. As used in one or more embodiments of this specification and the appended claims, the singular forms “a,” “said” and “the” are intended to include the plural forms as well, unless the context clearly dictates otherwise. It will also be understood that the term “and/or” as used in one or more embodiments of this specification refers to and encompasses any and all possible combinations of one or more of the associated listed items.

It should be understood that although the terms first, second, etc. may be used to describe various information in one or more embodiments of this specification, the information should not be limited to these terms. These terms are only used to distinguish information of the same type from each other. For example, without departing from the scope of one or more embodiments of this specification, the first may also be called the second, and similarly the second may also be called the first. Depending on the context, the word “if” as used herein may be interpreted as “when” or “at the time of” or “in response to determining”.

First, terminologies used in one or more embodiments of this specification will be explained.

MIE: Mixture of Informed Experts, a general expert mixture model, that is, a multi-expert network layer.

SAN-M: Memory Equipped Self-Attention for End-to-End Speech Recognition, a memory equipped self-attention model for end-to-end speech recognition.

Then, a speech recognition model provided by one or more embodiments of this specification will be described.

An accent refers to a voice with personal or local language features. At present, the recognition of speech with standard pronunciation has reached extremely high performance, but for recognition of speech of speakers with accents, the performance is far from sufficient. In daily life, when people from one region speak a language of another region, they tend to maintain their habitual way of pronunciation. Therefore, different accents may come out, and most speakers have an accent for pronunciation. Take Chinese as an example. There are eight major dialects for Chinese, namely Mandarin, Wu Chinese, Xiang Chinese, Gan Chinese, Hakka, Southern Hokkien, Northern Hokkien and Cantonese. Among them, Mandarin is the dialect closest to standard Chinese, and the other dialects differ significantly from standard Chinese in both acoustic pronunciation and linguistic performance. Since most Mandarin users master Mandarin as a second language, their Mandarin pronunciation is inevitably strongly affected by the pronunciation of their native dialects, resulting in the phenomena of inaccurate pronunciation, mispronunciation, etc., leading to reduced speech recognition performance of machines or smart devices. It can be seen that the exploration of multi-accent speech recognition is of great significance to the robustness of a speech recognition system.

A speech recognition method provided in an embodiment of this specification includes obtaining speech data to be recognized; extracting a speech feature in the speech data to obtain a first speech feature; performing accent feature recognition on the first speech feature to obtain a second speech feature carrying an accent feature; and recognizing, based on the second speech feature, first speech text content corresponding to the speech data. By performing the accent feature recognition on the first speech feature, the second speech feature carrying the accent feature can be obtained, and then during the speech text content recognition, the first speech text content corresponding to the speech data can be recognized based on the second speech feature carrying the accent feature, improving the accuracy of the first speech text content, that is, improving the accuracy and efficiency of speech recognition.

In this specification, a speech recognition method is provided, and this specification also relates to a speech recognition apparatus, a computing device, and a computer-readable storage medium, which are described in detail one by one in the following embodiments.

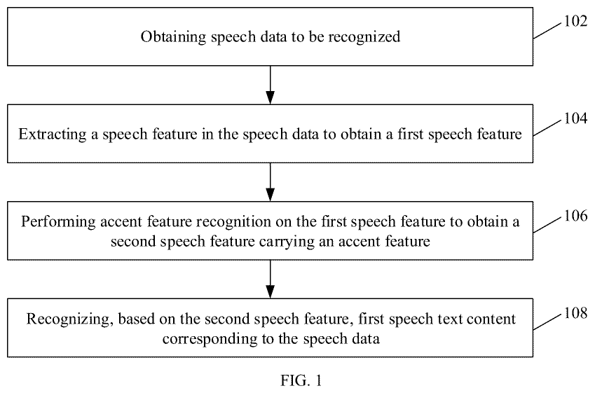

Referring to FIG. 1, FIG. 1 shows a flowchart of a speech recognition method provided in an embodiment of this specification. The method specifically includes the following steps.

Step 102: obtaining speech data to be recognized.

The execution body for implementing the speech recognition method could be a computing device having a speech recognition function, such as a server or a terminal with a speech recognition function.

Specifically, the speech data to be recognized may be one or more audios, or a segment of an audio.

In practical application, there are many ways to obtain the speech data to be recognized. For example, the operator may send a speech recognition instruction to the execution body, or send an instruction for obtaining the speech data to be recognized. Correspondingly, after receiving the instruction, the execution body begins to obtain the speech data to be recognized. It is also possible for the server to automatically obtain the speech data to be recognized at preset time intervals. For example, after a preset time period, the server with a speech recognition function automatically obtains the speech data to be recognized in a designated access area; or after a preset time period, the terminal with a speech recognition function automatically obtains the speech data to be recognized stored locally. This specification does not limit the way of obtaining the speech data to be recognized.

Step 104: extracting a speech feature in the speech data to obtain a first speech feature.

Specifically, the speech feature, also known as an acoustic feature, refers to feature information contained in speech, such as timbre, pitch, speech speed, etc.; the first speech feature refers to the speech feature obtained through preliminary speech feature extraction.

In a possible implementation of the embodiment of this specification, the speech feature in the speech data can be extracted through a speech recognition tool to obtain the first speech feature. For example, the Kaldi tool (an open source speech recognition tool) is used to perform speech feature extraction on the speech data. Since the Kaldi tool is specialized in extracting the speech feature, the first speech feature can be obtained. In this way, the efficiency of obtaining the first speech feature can be improved by extracting the first speech feature using the speech recognition tool.

In another possible implementation of the embodiment of this specification, in order to improve the accuracy of the first speech feature and improve the signal-to-noise ratio, it is possible to perform sampling processing on the speech data first, and then perform speech feature extraction on the sampled data. That is, the specific implementation process for extracting the speech feature in the speech data to obtain the first speech feature can be as follows:
performing sampling processing on the speech data to obtain a sampling result for the speech data; and
performing speech feature extraction on the sampling result for the speech data to obtain the first speech feature.

Specifically, sampling processing, i.e., audio sampling, refers to sampling an analog signal, i.e., speech data, in a unit time. The higher the sampling frequency is, the more realistic and natural the waveform of the mechanical wave is.

In practical application, the speech data can be processed by a preset sampling tool to obtain the sampled data, i.e., the sampling result, and further, the speech feature in the sampling result is extracted to obtain the first speech feature. It is also possible to perform sampling processing on the speech data through a preset convolutional neural network to obtain the sampled data, i.e., the sampling result, and further, the speech feature in the sampling result is extracted to obtain the first speech feature.

It should be noted that the sampling processing can be up-sampling or down-sampling. In this specification, the sampling processing is preferably down-sampling.

Step 106: performing accent feature recognition on the first speech feature to obtain a second speech feature carrying an accent feature.

Specifically, the accent refers to a voice with personal or local language features; the accent feature refers to a feature of an accent carried in the speech data; and the second speech feature refers to a speech feature carrying the accent feature.

In practical application, a tool or a model with an accent feature recognition function can be used to perform accent feature recognition on the first speech feature to obtain the second speech feature carrying the accent feature.

In addition, the second speech feature can be the same as the first speech feature, except that in comparison with the first speech feature, the second speech feature further carries the accent feature. Therefore, speech recognition using the second speech feature is more robust than speech recognition using the first speech feature.

Step 108: recognizing, based on the second speech feature, first speech text content corresponding to the speech data.

Specifically, the speech text content refers to the text corresponding to the speech or the audio or some speech data; the first speech text content is the speech text content corresponding to the speech data to be recognized.

In a possible implementation of the embodiment of this specification, on the basis of obtaining the second speech feature carrying the accent feature, the first speech text content corresponding to the speech data can be further determined according to the second speech feature and the accent feature.

In a possible implementation of the embodiment of this specification, if the speech data is an audio segment of an audio to be recognized, in order to improve the precision and accuracy of speech recognition, it is also possible to recognize the first speech text content of the speech data based on second speech text content of an audio segment adjacent to the speech data in the audio to be recognized. That is, when the speech data is an audio segment of the audio to be recognized, the specific implementation process for recognizing, based on the second speech feature, the first speech text content corresponding to the speech data can be as follows:
obtaining second speech text content of adjacent speech data, where the adjacent speech data is an audio segment adjacent to the speech data in the audio to be recognized; and
recognizing the first speech text content corresponding to the speech data according to the second speech feature, the accent feature and the second speech text content.

Specifically, the audio to be recognized refers to a file storing sound content on which speech recognition needs to be performed; the audio segment refers to one of sub-audios into which the audio to be recognized is divided; the adjacent speech data refers to the audio segment adjacent to the speech data in the audio to be recognized. For example, if the speech data is the third audio segment in the audio to be recognized, then the adjacent speech data is at least one of the second audio segment and the fourth audio segment in the audio to be recognized. The second speech text content is the speech text content corresponding to the adjacent speech data.

In practical application, when the speech data is an audio segment of the audio to be recognized, it is possible to obtain the speech text content of the adjacent audio segment to the audio segment in the audio to be recognized, that is, to obtain the second speech text content of the adjacent speech data. Further, the first speech text content corresponding to the speech data is recognized based on the second speech feature carrying the accent feature and the second speech text content. Since the speech data to be recognized is related to the upper or lower speech data of the speech data, that is, the adjacent speech data, the accuracy of the first speech text content can be improved when recognizing the first speech text content corresponding to the speech data with reference to the second speech text of the adjacent speech data.

In addition, since when speech recognition is performed on the audio to be recognized, it is generally recognized from the first audio segment to the last audio segment. That is, at speech recognition on the speech data, the speech text content of the previous audio segment corresponding to the speech data has been obtained, and the next audio segment corresponding to the speech data is still waiting for speech recognition. At this time, only the speech text content of the previous audio segment can be obtained. Therefore, preferably, the adjacent speech data is the previous audio segment adjacent to the speech data in the audio to be recognized.

In a possible implementation of the embodiment of this specification, before speech recognition is performed on the speech data, a pre-trained speech recognition model can be obtained, and then the speech data is input into the speech recognition model, and the speech recognition model performs processing such as speech feature extraction, accent feature recognition and speech text content recognition on the speech data to obtain the first speech text content corresponding to the speech data. That is, before extracting the speech feature in the speech data to obtain the first speech feature, the method further includes:
obtaining a pre-trained speech recognition model, where the speech recognition model includes an encoding layer, a multi-expert network layer, and a decoding layer.

Accordingly, extracting the speech feature in the speech data to obtain the first speech feature can be as follows:
inputting the speech data into the encoding layer to extract the speech feature to obtain the first speech feature.

Accordingly, performing accent feature recognition on the first speech feature to obtain the second speech feature carrying the accent feature can be as follows:
inputting the first speech feature into the multi-expert network layer for accent feature recognition to obtain the second speech feature carrying the accent feature.

Accordingly, recognizing, based on the second speech feature, the first speech text content corresponding to the speech data can be as follows:
inputting the second speech feature carrying the accent feature into the decoding layer to perform recognition on the speech data to obtain the first speech text content.

Specifically, the speech recognition model refers to a pre-trained neural network model; encoding refers to the process of completing the feature extraction of input data once; the encoding layer refers to a sub-model for speech feature extraction in the speech recognition model; the multi-expert network layer refers to a sub-module for accent feature recognition in the speech recognition model; decoding refers to the process of performing the feature extraction operation in a target direction according to given input data; the decoding layer refers to a sub-model for speech text content recognition in the speech recognition model.

In practical application, after the speech data to be recognized is obtained, the pre-trained speech recognition model including the encoding layer, the multi-expert network layer and the decoding layer is obtained. Then the speech data is input into the encoding layer, and the encoding layer extracts the speech feature in the speech data and outputs the first speech feature; then the first speech feature is input into the multi-expert network layer, and the multi-expert network layer performs accent feature recognition on the first speech feature and outputs the second speech feature carrying the accent feature; then the second speech feature carrying the accent feature is input into the decoding layer, and the decoding layer performs recognition on the speech data based on the accent feature and the second speech feature, and outputs the first speech text content. Speech recognition on the speech data through a pre-trained speech recognition model can improve the speech recognition rate and accuracy.

Before obtaining the pre-trained speech recognition model, a to-be-trained model needs to be trained so as to obtain the speech recognition model with a speech recognition function. That is, before obtaining the pre-trained speech recognition model, the method further includes:
obtaining an accent speech training sample set and a preset to-be-trained model, where the accent speech training sample set contains multiple accent speech samples;
extracting any accent speech sample from the multiple accent speech samples and inputting the accent speech sample into the to-be-trained model to obtain an output result; and
determining a loss value according to the output result, and adjusting a model parameter of the to-be-trained model according to the loss value, continuing to perform the step of extracting any accent speech sample from the multiple accent speech samples, and determining the to-be-trained model after training as the speech recognition model when a first preset training stop condition is met.

Specifically, the to-be-trained model refers to a pre-specified neural network model; the multiple accent speech samples refer to speech data samples or audio samples carrying different accents; the accent speech training sample set refers to a set combined with samples used to train the to-be-trained model, that is, a set of multiple accent speech samples; the first training stop condition can be that the loss value is less than or equal to a preset threshold, or that the number of iterative training reaches a preset iteration value.

In actual applications, there are many ways to obtain the accent speech training sample set and the preset to-be-trained model. For example, the operator may send a training instruction for the to-be-trained model to the execution body, or send an instruction for obtaining the accent speech training sample set and the preset to-be-trained model. Accordingly, after receiving the instruction, the execution body starts to obtain the accent speech training sample set and the preset to-be-trained model. It is also possible for the server to automatically obtain the accent speech training sample set and the preset to-be-trained model at preset time intervals. For example, after a preset time period, the server with a speech recognition function automatically obtains the accent speech training sample set and the preset to-be-trained model in a designated access area; or after a preset time period, the terminal with a speech recognition function automatically obtains the accent speech training sample set and the preset to-be-trained model stored locally. This specification does not limit the way of obtaining the accent speech training sample set and the preset to-be-trained model.

After the accent speech training sample set and the preset to-be-trained model are obtained, the to-be-trained model is trained based on the accent speech training sample set to obtain the speech recognition model. An accent speech sample can be extracted from the accent speech training sample set, and then the accent speech sample is input into the to-be-trained model, and then the to-be-trained model processes the accent speech sample to obtain an output result of the to-be-trained model for the accent speech sample. Then, a loss value is determined according to the output result and a preset loss function. When the first preset training stop condition is not met, the model parameter of the to-be-trained model is adjusted according to the loss value. Then any accent speech sample is extracted from the multiple accent speech samples again to perform the next round of training. When the first preset training stop condition is met, the to-be-trained model after training is determined as the speech recognition model. In this way, unsupervised training is performed on the to-be-trained model by using the accent speech training sample set, which improves the accuracy and rate of the speech recognition model in recognition on speech data with an accent, and improves the robustness of the speech recognition model.

In a possible implementation of the embodiment of this specification, the to-be-trained model includes four processing layers: a sampling layer, an encoding layer, a multi-expert network layer and a decoding layer. At this time, the specific implementation process for inputting the accent speech sample into the to-be-trained model to obtain the output result can be as follows:
inputting the accent speech sample into the sampling layer for sampling processing to obtain a sampling result for the accent speech sample;
inputting the sampling result into the encoding layer for speech feature extraction to obtain a first predicted speech feature; and
inputting the first predicted speech feature into the multi-expert network layer for accent feature recognition to obtain a second predicted speech feature carrying an accent feature.

Accordingly, the specific implementation process for determining the loss value according to the output result, and adjusting the model parameter of the to-be-trained model according to the loss value can be as follows:
calculating the loss value according to the sampling result, the first predicted speech feature and the second predicted speech feature, and adjusting the model parameter of the to-be-trained model according to the loss value.

Specifically, sampling processing, i.e., audio sampling, refers to sampling the analog signal, i.e., speech data, in a unit time. The higher the sampling frequency is, the more realistic and natural the waveform of the mechanical wave is; the sampling layer refers to a sub-model for sampling the accent speech sample; encoding refers to the process of completing the feature extraction of the input data once; the encoding layer refers to a sub-model for speech feature extraction in the speech recognition model; the multi-expert network layer refers to a sub-module for accent feature recognition in the speech recognition model; decoding refers to the process of performing the feature extraction operation in a target direction according to the given input data; the decoding layer refers to a sub-model for speech text content recognition in the speech recognition model.

In practical application, after any accent speech sample is extracted from the multiple accent speech samples, the accent speech sample needs to be input into the sampling layer, and the sampling layer performs sampling processing on the accent speech sample to obtain an output result of the sampling layer, that is, the sampling result; then the sampling result is input into the encoding layer, and the encoding layer extracts the speech feature in the sampling result to obtain an output result of the encoding layer, that is, the first predicted speech feature; then the first predicted speech feature is input into the multi-expert network layer, and the multi-expert network layer performs accent feature recognition processing on the first predicted speech feature to obtain an output result of the multi-expert network layer, that is, the second predicted speech feature with the accent feature; finally, the loss value is determined according to the sampling result, the first predicted speech feature, the second predicted speech feature and the preset loss function, and the model parameter of the to-be-trained model is adjusted according to the loss value when the first preset training stop condition is not met. In this way, the loss value is calculated according to the output results of the sampling layer, the encoding layer and the multi-expert network layer in the to-be-trained model, and the model parameter is adjusted based on the loss value, so that the model parameter of the to-be-trained model can converge quickly, thereby improving the training efficiency of the to-be-trained model, that is, the speech recognition model.

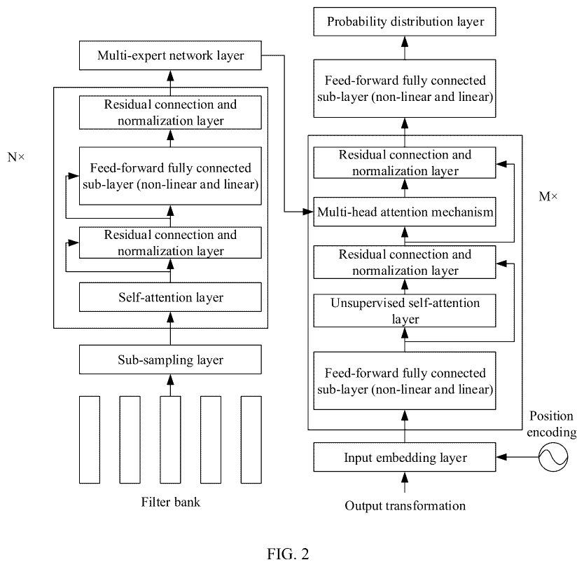

Referring to FIG. 2, FIG. 2 shows a schematic structural diagram of a to-be-trained model in a speech recognition method provided in an embodiment of the present specification. A SAN-M framework is adopted for the to-be-trained model which includes a sampling layer, an encoding layer, a multi-expert network layer and a decoding layer. A filter bank and a sub-sampling layer constitute the sampling layer. A self-attention layer, a residual connection and normalization layer, a feed-forward fully connected sub-layer (non-linear and linear) and a residual connection and normalization layer constitute the encoding layer. A feed-forward fully connected sub-layer (non-linear and linear), an unsupervised self-attention layer, a residual connection and normalization layer, a multi-head attention mechanism and a residual connection and normalization layer constitute the decoding layer. A feed-forward fully connected sub-layer (non-linear and linear) and a probability distribution layer are used to output the result. It should be noted that there may be N number of encoding layers and M number of decoding layers in the to-be-trained model, where N and M are both positive integers. In this specification, only one encoding layer and one decoding layer are taken as an example for illustration purposes. In addition, the to-be-trained model further includes output transformation, an input embedding layer, and position encoding. In the case of obtaining the second speech text content of the adjacent speech data and recognizing the first speech text content corresponding to the speech data according to the second speech feature, the accent feature and the second speech text content, the output transformation and the position encoding work together to obtain the second speech text content of the adjacent speech data, and the input embedding layer is used to input the second speech text content into the decoding layer.

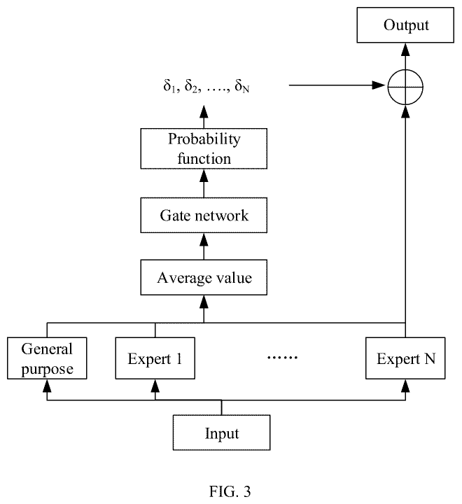

Referring to FIG. 3, FIG. 3 shows a schematic structural diagram of a multi-expert network layer in a speech recognition method provided by an embodiment of this specification. The multi-expert network layer includes input, output, N experts, a general purpose and a calculation area, where the calculation area includes average value calculation, gate network calculation, and probability function calculation, where results of the probability function calculation are represented by δ₁, δ₂, . . . , δ_{N}.

In an implementation, in order to improve the model training efficiency, calculating the loss value according to the sampling result, the first predicted speech feature and the second predicted speech feature and adjusting the model parameter of the to-be-trained model according to the loss value can be as follows:
calculating a first sub-loss value according to the second predicted speech feature and the sampling result, and calculating a second sub-loss value according to the first predicted speech feature and the second predicted speech feature; and
adjusting a first model parameter of the encoding layer based on the first sub-loss value, and adjusting a second model parameter of the multi-expert network layer based on the second sub-loss value.

Specifically, the first sub-loss value and the second sub-loss value are two sub-loss values for the loss value, the first sub-loss value is a loss value corresponding to the encoding layer, and the second sub-loss value is a loss value corresponding to the multi-expert network layer; the first model parameter refers to a parameter of the encoding layer; the second model parameter refers to a parameter of the multi-expert network layer.

In practical application, after the sampling result, the first predicted speech feature and the second predicted speech feature are obtained, the first sub-loss value needs to be calculated based on the sampling result, the second predicted speech feature and a preset first sub-loss function, and the second sub-loss value needs to be calculated based on the first predicted speech feature, the second predicted speech feature and a preset second sub-loss function. Then, the first model parameter of the encoding layer is adjusted based on the first sub-loss value, and the second model parameter of the multi-expert network layer is adjusted based on the second sub-loss value. In this way, the first model parameter of the encoding layer is adjusted through the input and the output of the encoding layer in the to-be-trained model, and the second model parameter of the multi-expert network layer is adjusted through the input and the output of the multi-expert network layer, so that the model parameters can be quickly adjusted to improve the efficiency and accuracy of model training.

That is, through the above method, a separate training can be performed only to the encoding layer and the multi-expert network layer, without the need to train the entire speech recognition model. After the training of the encoding layer and the multi-expert network layer is completed, the encoding layer and the multi-expert network layer are simply added to the speech recognition model.

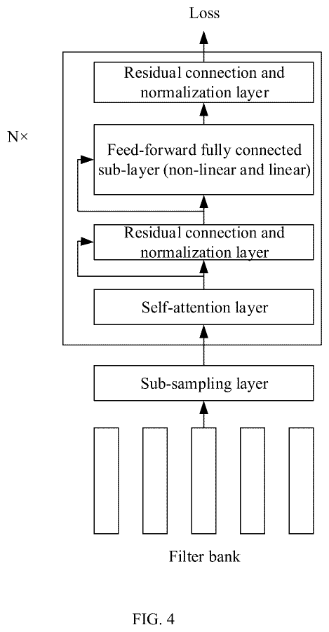

On the basis of FIG. 2, FIG. 4 shows a schematic structural diagram of a sampling layer and an encoding layer in a speech recognition method provided by an embodiment of the present specification. The filter bank and the sub-sampling layer constitute the sampling layer; the self-attention layer, the residual connection and normalization layer, the feed-forward fully connected sub-layer (non-linear and linear) and the residual connection and normalization layer constitute the encoding layer, and there are N number of encoding layers. The accent speech sample passes through two layers of convolutional neural networks with a step size of 2, that is, after the sampling layer performs sampling, the obtained sampling result is input into the serial encoding layers, and finally the output of the encoding layers and the output of the sampling layer are used to calculate the loss, that is, the first sub-loss value is calculated according to the second predicted speech feature and the sampling result.

An unsupervised pre-training approach (a proposed wav2vec2.0 pre-training approach) is adopted for training the speech recognition model, referring to FIG. 4, such as using 15,000 hours of English data to pre-train the encoding layer and the multi-expert network layer in the speech recognition model, and then using a small amount of annotated multi-accent English data to fine-tune the speech recognition model.

In a possible implementation of the embodiment of this specification, in the process of inputting the first predicted speech feature into the multi-expert network layer for accent feature recognition to obtain the second predicted speech feature carrying the accent feature, it is possible to only input the first predicted speech feature output by the encoding layer into the multi-expert network layer for accent feature recognition to obtain the second predicted speech feature carrying the accent feature.

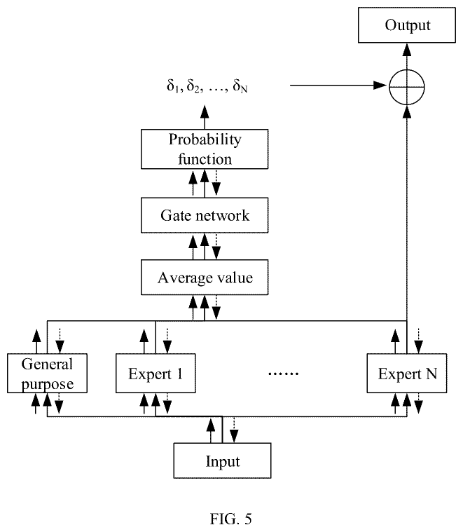

Referring to FIG. 5, on the basis of FIG. 3, FIG. 5 shows a schematic diagram of a structure for adjusting a model parameter of a multi-expert network layer in a speech recognition method provided by an embodiment of the present specification. That is, the second model parameter of the multi-expert network layer is adjusted based on an automatic method: during training the to-be-trained model, forward and backward calculations are performed for all modules (input, output, N experts, a general purpose and a calculation area) in the multi-expert network layer to update the model parameter.

In a possible implementation of the embodiment of the present specification, it is also possible to splice the first predicted speech feature output by the encoding layer and an accent embedding feature of the accent speech sample, and then input the first predicted speech feature spliced with the accent embedding feature into the multi-expert network layer for accent feature recognition to obtain the second predicted speech feature carrying the accent feature. That is, before inputting the first predicted speech feature into the multi-expert network layer for accent feature recognition to obtain the second predicted speech feature carrying the accent feature, the method further includes:
obtaining an accent embedding feature of the accent speech sample.

Accordingly, inputting the first predicted speech feature into the multi-expert network layer for accent feature recognition to obtain the second predicted speech feature carrying the accent feature includes:
splicing the accent embedding feature to the first predicted speech feature, inputting the first predicted speech feature spliced with the accent embedding feature into the multi-expert network layer for accent feature recognition to obtain the second predicted speech feature carrying the accent feature.

Specifically, the accent embedding feature refers to an embedding feature of the accent corresponding to the accent speech sample.

In practical application, in order to improve more quickly the ability of the multi-expert network layer to extract the accent feature, first the accent embedding feature of the accent speech sample can be obtained through a preset accent embedding feature obtaining strategy, and then the accent embedding feature is spliced to the first predicted speech feature output by the encoding layer to obtain the first predicted speech feature spliced with the accent embedding feature, and then the first predicted speech feature spliced with the accent embedding feature is input into the multi-expert network layer for accent feature recognition to obtain the second predicted speech feature carrying the accent feature.

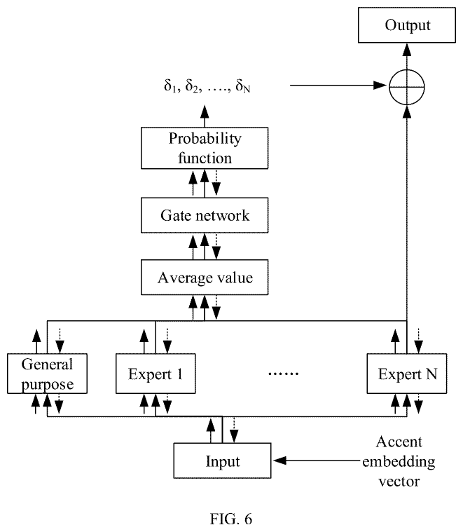

Referring to FIG. 6, on the basis of FIG. 3, FIG. 6 shows a schematic diagram of a structure for adjusting a model parameter of a multi-expert network layer in another speech recognition method provided by an embodiment of this specification. That is, the second model parameter of the multi-expert network layer is adjusted based on an embedding guide method: during training the to-be-trained model, an accent embedding vector is spliced to the first predicted speech feature, and then the first predicted speech feature spliced with the accent embedding feature is input to the multi-expert network layer, and at this time, forward and backward calculations are performed for all modules (input, output, N experts, a general purpose and a calculation area) in the multi-expert network layer to update the model parameter.

In a possible implementation of the embodiment of the present specification, it is also possible to input the first predicted speech feature output by the encoding layer and an accent label of the accent speech sample into the multi-expert network layer for accent feature recognition to obtain the second predicted speech feature carrying the accent feature. That is, before inputting the first predicted speech feature into the multi-expert network layer for accent feature recognition to obtain the second predicted speech feature carrying the accent feature, the method further includes:
obtaining an accent label of the accent speech sample.

Accordingly, inputting the first predicted speech feature into the multi-expert network layer for accent feature recognition to obtain the second predicted speech feature carrying the accent feature includes:
inputting the accent label and the first predicted speech feature into the multi-expert network layer for accent feature recognition to obtain the second predicted speech feature carrying the accent feature.

Accordingly, adjusting the second model parameter of the multi-expert network layer based on the second sub-loss value includes:
determining a to-be-adjusted model parameter of the multi-expert network layer according to the accent label; and
adjusting the to-be-adjusted model parameter based on the second sub-loss value.

Specifically, the accent label refers to the type of accent, such as Sichuan accent, Shandong accent, Northeastern accent, etc.

In practical application, in order to improve more quickly the ability of the multi-expert network layer to extract the accent feature, first the accent label of the accent speech sample can be obtained through a preset accent label obtaining strategy, and then the first predicted speech feature output by the encoding layer and the accent label are input to the multi-expert network layer for accent feature recognition to obtain the second predicted speech feature carrying the accent feature. Furthermore, during adjusting the second model parameter of the multi-expert network layer, the corresponding to-be-adjusted model parameter needs to be determined according to the accent label, and then the to-be-adjusted model parameter is adjusted according to the second sub-loss value.

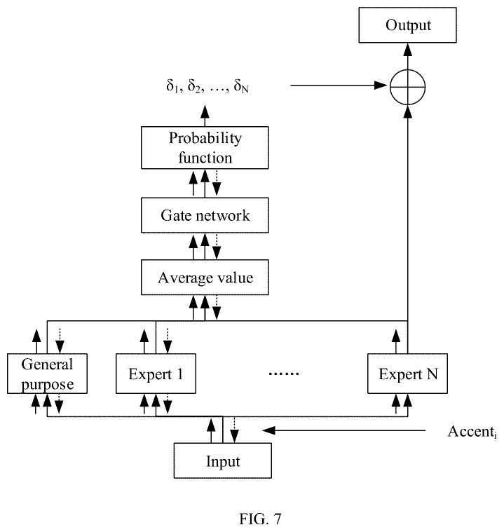

Referring to FIG. 7, on the basis of FIG. 3, FIG. 7 shows a schematic diagram of a structure for adjusting a model parameter of a multi-expert network layer in yet another speech recognition method provided in an embodiment of the present specification. That is, the second model parameter of the multi-expert network layer is adjusted based on a label guide method: during training the to-be-trained model, the accent label (Accentᵢ) and the first predicted speech feature are input into the multi-expert network layer, and at this time, forward calculations are performed for all modules (input, output, N experts, a general purpose and a calculation area) in the multi-expert network layer, but only the parameter of the expert module corresponding to the accent label is updated, for example, if the input accent label is 1, only the parameters of the general purpose and expert 1 are updated, and if the input accent label is 2, only the parameters of the general purpose and expert 2 are updated.

Specifically, an accent classifier of a target domain can be used to perform accent annotation on a large number of accent speech samples to obtain accent labels and/or accent embedding features, and then a large number of accent speech samples and accent labels, or accent speech samples and accent embedding features are used for unsupervised pre-training, which can improve the accuracy of the speech recognition model for multi-accent speech recognition.

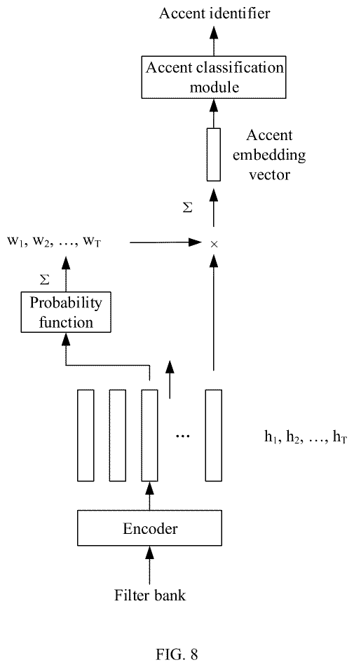

Referring to FIG. 8, FIG. 8 shows a schematic structural diagram of an accent classifier in a speech recognition method provided in an embodiment of the present specification. The accent classifier includes a filter bank, an encoder, a convolution layer (h₁, h₂, . . . , h_{T}), probability function calculation, and an accent classification module, where the calculation result of the probability function calculation is (w₁, w₂, . . . , w_{T}), and an accent embedding vector is obtained after processing on (w₁, w₂, . . . , w_{T}), and the accent embedding vector is passed through the accent classification module to obtain an accent identifier.

Since the current wav2vec2 unsupervised pre-training does not contain information of different domains (accents), when the MIE module (the multi-expert network layer) is applied to unsupervised pre-training (multi-domain pre-training), the accent classifier is used to provide accent information (accent embedding vectors and/or accent identifiers) to massive data (accent speech samples), so that the multi-expert network layer can pre-learn the accent information of the accent speech samples through multi-domain pre-training.

In order to further improve the speech recognition efficiency of the speech recognition model, after the speech recognition model is obtained after training, the speech recognition model can be corrected and fine-tuned using an accent speech correction sample with the accent speech label. That is, after determining the to-be-trained model after training as the speech recognition model when the first preset training stop condition is met, the method further includes:
obtaining an accent speech correction sample set, where the accent speech correction sample set contains multiple accent speech correction samples each carrying an accent speech label;
extracting any accent speech correction sample from the accent speech correction sample set and inputting the accent speech correction sample into the speech recognition model to obtain a predicted recognition result;
determining a difference value according to the predicted recognition result and the accent speech label carried by the accent speech correction sample; and
adjusting the model parameter of the speech recognition model according to the difference value, continuing to perform the step of extracting any accent speech correction sample from the accent speech correction sample set, and obtain a target speech recognition model when a second preset training stop condition is met.

Specifically, the accent speech label refers to the real accent speech text content of the accent speech correction sample; the accent speech correction samples refer to speech data samples or audio samples with different accents that are used to correct and fine-tune the speech recognition model; the accent speech correction sample set refers to a set of samples used to correct and fine-tune the speech recognition model, that is, the set of accent speech correction samples; the predicted recognition result refers to the predicted accent speech text content of the accent speech correction sample recognized by the speech recognition model; the second training stop condition can be that the difference value is less than or equal to a preset threshold, or that the number of iterative training reaches a preset iteration value.

In practical application, there are many ways to obtain the accent speech correction sample set. For example, the operator may send an adjustment instruction for the speech recognition model to the execution body, or send an instruction for obtaining the accent speech correction sample set. Accordingly, after receiving the instruction, the execution body starts to obtain the accent speech correction sample set. It is also possible for the server to automatically obtain the accent speech correction sample set at preset time intervals. For example, after a preset time period, the server with the speech recognition function automatically obtains the accent speech correction sample set in the designated access area; or after a preset time period, the terminal with the speech recognition function automatically obtains the accent speech correction sample set stored locally. This specification does not limit the way of obtaining the accent speech correction sample set.

After the accent speech correction sample set is obtained, the speech recognition model is adjusted and corrected based on the accent speech correction sample set to obtain the target speech recognition model. An accent speech correction sample carrying an accent speech label can be extracted from the accent speech correction sample set, and then the accent speech correction sample is input into the speech recognition model, and then the speech recognition model processes the accent speech correction sample to obtain an output result of the speech recognition model for the accent speech sample, that is, the predicted recognition result. Then, the difference value is calculated according to the predicted recognition result, the accent speech label carried by the accent speech correction sample and a preset difference value determining function. When the second preset training stop condition is not met, the model parameter of the speech recognition model is adjusted according to the difference value, and then an accent speech correction sample carrying an accent speech label is extracted from the accent speech correction sample set again to perform a next round of training; when the second preset training stop condition is met, it is determined that the adjustment and correction of the speech recognition model are completed, and the target speech recognition model is obtained. In this way, by adjusting and correcting the speech recognition model through the accent speech correction sample set, the accuracy and rate of the speech recognition model in recognition on the speech data with an accent can be improved, and the robustness of the speech recognition model can be improved.

In a possible implementation of the embodiment of this specification, in the process of inputting the accent speech correction sample into the speech recognition model to obtain the predicted recognition result, the accent speech correction sample can be input into the encoding layer for speech feature extraction to obtain a third predicted speech feature; then the third predicted speech feature and the accent identifier are input into the multi-expert network layer for accent feature recognition to obtain a fourth predicted speech feature carrying the accent feature; and the fourth predicted speech feature carrying the accent feature is input into the decoding layer to perform recognition to obtain the predicted recognition result.

In another possible implementation of the embodiment of this specification, it is also possible to first obtain the accent identifier of the accent speech correction sample, and then input the accent speech correction sample and the accent identifier into the speech recognition model to obtain the predicted recognition result. That is, the specific implementation process for inputting the accent speech correction sample and the accent identifier into the speech recognition model to obtain the predicted recognition result can be as follows:
obtaining an accent identifier of the accent speech correction sample;
inputting the accent speech correction sample into the encoding layer for speech feature extraction to obtain a third predicted speech feature;
inputting the third predicted speech feature and the accent identifier into the multi-expert network layer for accent feature recognition to obtain a fourth predicted speech feature carrying an accent feature; and
inputting the fourth predicted speech feature carrying the accent feature into the decoding layer to perform recognition to obtain the predicted recognition result.

Specifically, the accent identifier can be an accent embedding feature or an accent label.

In practical application, the accent identifier of the accent speech sample can be obtained through a preset accent identifier obtaining strategy.

In the case where the accent identifier is an accent embedding feature, the accent speech correction sample is input into the encoding layer for speech feature extraction to obtain the third predicted speech feature, and then the accent embedding feature is spliced to the third predicted speech feature output by the encoding layer to obtain the third predicted speech feature spliced with the accent embedding feature, and then the third predicted speech feature spliced with the accent embedding feature is input into the multi-expert network layer for accent feature recognition to obtain the fourth predicted speech feature carrying the accent feature, and then the fourth predicted speech feature carrying the accent feature is input into the decoding layer to perform recognition to obtain the predicted recognition result.

In the case where the accent identifier is an accent label, the accent speech correction sample is input into the encoding layer for speech feature extraction to obtain the third predicted speech feature, and then the accent label and the third predicted speech feature are input into the multi-expert network layer for accent feature recognition to obtain the fourth predicted speech feature carrying the accent feature, and then the fourth predicted speech feature carrying the accent feature is input into the decoding layer to perform recognition to obtain the predicted recognition result.

It should be noted that when the speech recognition model includes the sampling layer, the accent speech correction sample needs to be input into the sampling layer for sampling processing to obtain the predicted sampling result, and then the predicted sampling result is input into the encoding layer for speech feature extraction to obtain the third predicted speech feature.

If training is performed by the automatic method, the speech recognition model is corrected and fine-tuned by the automatic method; if training is performed in the embedding guide method, the speech recognition model is corrected and fine-tuned by the embedding guide method; if training is performed by the label guide method, the speech recognition model is corrected and fine-tuned by any one of the automatic method, the onehot guide method and the label guide method. The onehot guide method is similar to the label guide method, except that the onehot guide method uses the onehot vector of the accent as the embedding vector for splicing to the input, while the embedding guide extracts the accent embedding vector from the accent classifier for splicing to the input.

The lack of resources for speech data with accents is a difficulty in multi-accent speech recognition. Unsupervised pre-training can utilize a large amount of unlabeled speech data, which can significantly improve low-resource speech recognition. This specification proposes expert-based unsupervised multi-domain pre-training based on the SAN-M model that includes the MIE module to explore its impact on the performance of general accent speech recognition. In terms of core technology, the MIE module is used for a series of explorations. The MIE module is applied to multilingual speech recognition, and is applied to the exploration of different acoustic models for multilingual speech recognition, and is also used in the exploration of multi-dialect speech recognition. However, the MIE module is not used in the exploration of multi-accent speech recognition, and there is no exploration of a solution for combining a large amount of unlabeled data with expert networks. The MIE module and a large amount of unlabeled audio (accent speech samples) are used for pre-training to effectively solve the problem of lack of multi-accent data resources.

The speech recognition method provided in an embodiment of this specification includes obtaining speech data to be recognized; extracting a speech feature in the speech data to obtain a first speech feature; performing accent feature recognition on the first speech feature to obtain a second speech feature carrying an accent feature; recognizing, based on the second speech feature, first speech text content corresponding to the speech data. By performing the accent feature recognition on the first speech feature, the second speech feature carrying the accent feature can be obtained, and then during the speech text content recognition, the first speech text content corresponding to the speech data can be recognized based on the second speech feature carrying the accent feature, improving the accuracy of the first speech text content, that is, improving the accuracy and efficiency of speech recognition.

In addition, based on the MIE module, unsupervised multi-domain pre-training is used for training the speech recognition model, so that the speech recognition model not only has the ability to obtain context information in the unsupervised pre-training stage, but also has certain domain information, which is conducive to the training of multi-accent speech recognition in downstream tasks.

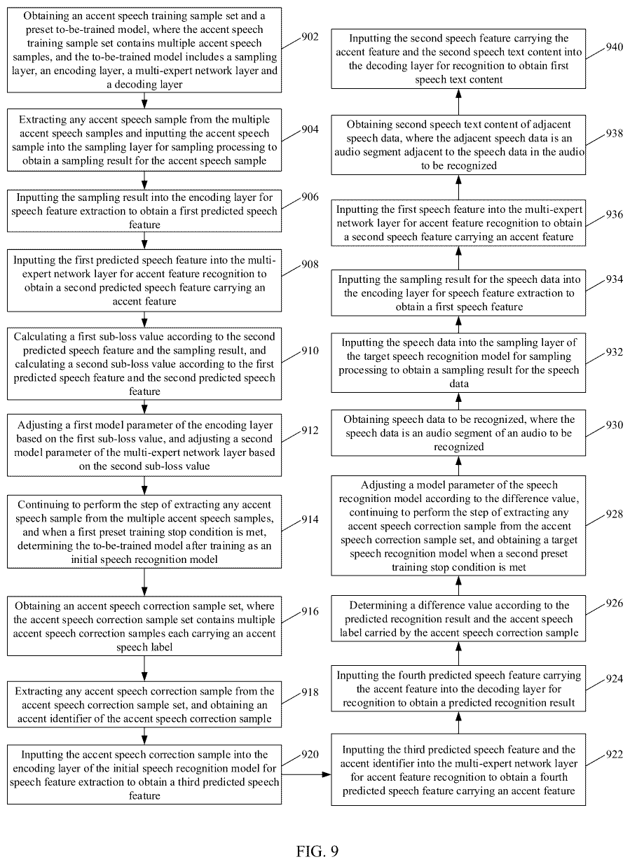

The speech recognition method is further described below in conjunction with FIG. 9. FIG. 9 shows a flowchart of a processing procedure of a speech recognition method provided by an embodiment of the present specification, which specifically includes the following steps.

Step 902: obtaining an accent speech training sample set and a preset to-be-trained model, where the accent speech training sample set contains multiple accent speech samples, and the to-be-trained model includes a sampling layer, an encoding layer, a multi-expert network layer, and a decoding layer.

Step 904: extracting any accent speech sample from the multiple accent speech samples and inputting the accent speech sample into the sampling layer for sampling processing to obtain a sampling result for the accent speech sample.

Step 906: inputting the sampling result into the encoding layer for speech feature extraction to obtain a first predicted speech feature.

Step 908: inputting the first predicted speech feature into the multi-expert network layer for accent feature recognition to obtain a second predicted speech feature carrying an accent feature.

In an implementation, before inputting the first predicted speech feature into the multi-expert network layer for accent feature recognition to obtain the second predicted speech feature carrying the accent feature, the method further includes:
obtaining an accent embedding feature of the accent speech sample.

Accordingly, inputting the first predicted speech feature into the multi-expert network layer for accent feature recognition to obtain the second predicted speech feature carrying the accent feature includes:
splicing the accent embedding feature to the first predicted speech feature and inputting the first predicted speech feature spliced with the accent embedding feature into the multi-expert network layer for accent feature recognition to obtain the second predicted speech feature carrying the accent feature.

Step 910: calculating a first sub-loss value according to the second predicted speech feature and the sampling result, and calculating a second sub-loss value according to the first predicted speech feature and the second predicted speech feature.

Step 912: adjusting a first model parameter of the encoding layer based on the first sub-loss value, and adjusting a second model parameter of the multi-expert network layer based on the second sub-loss value.

In an implementation, before inputting the first predicted speech feature into the multi-expert network layer for accent feature recognition to obtain the second predicted speech feature carrying the accent feature, the method further includes:
obtaining an accent label of the accent speech sample.

Accordingly, inputting the first predicted speech feature into the multi-expert network layer for accent feature recognition to obtain the second predicted speech feature carrying the accent feature includes:
inputting the accent label and the first predicted speech feature into the multi-expert network layer for accent feature recognition to obtain the second predicted speech feature carrying the accent feature;
adjusting the second model parameter of the multi-expert network layer based on the second sub-loss value includes:
determining a to-be-adjusted model parameter of the multi-expert network layer according to the accent label; and
adjusting the to-be-adjusted model parameter based on the second sub-loss value.

Step 914: continuing to perform the step of extracting any accent speech sample from the multiple accent speech samples, and when the first preset training stop condition is met, determining the to-be-trained model after training as an initial speech recognition model.

Step 916: obtaining an accent speech correction sample set, where the accent speech correction sample set contains multiple accent speech correction samples each carrying an accent speech label.

Step 918: extracting any accent speech correction sample from the accent speech correction sample set, and obtaining an accent identifier of the accent speech correction sample.

Step 920: inputting the accent speech correction sample into the encoding layer of the initial speech recognition model for speech feature extraction to obtain a third predicted speech feature.

Step 922: inputting the third predicted speech feature and the accent identifier into the multi-expert network layer for accent feature recognition to obtain a fourth predicted speech feature carrying an accent feature.

Step 924: inputting the fourth predicted speech feature carrying the accent feature into the decoding layer to perform recognition, to obtain a predicted recognition result.

Step 926: determining a difference value according to the predicted recognition result and the accent speech label carried by the accent speech correction sample.

Step 928: adjusting a model parameter of the speech recognition model according to the difference value, continuing to perform the step of extracting any accent speech correction sample from the accent speech correction sample set, and obtaining a target speech recognition model when a second preset training stop condition is met.

Step 930: obtaining speech data to be recognized, where the speech data is an audio segment of an audio to be recognized.

Step 932: inputting the speech data into the sampling layer of the target speech recognition model for sampling processing to obtain a sampling result for the speech data.

Step 934: inputting the sampling result for the speech data into the encoding layer for speech feature extraction to obtain a first speech feature.

Step 936: inputting the first speech feature into the multi-expert network layer for accent feature recognition to obtain a second speech feature carrying an accent feature.

Step 938: obtaining second speech text content of adjacent speech data, where the adjacent speech data is an audio segment adjacent to the speech data in the audio to be recognized.

Step 940: inputting the second speech feature carrying the accent feature and the second speech text content into the decoding layer to perform recognition to obtain first speech text content.

In the speech recognition method provided in an embodiment of the present specification, the second speech feature carrying the accent feature can be obtained by performing accent feature recognition on the first speech feature, and then during speech text content recognition, the first speech text content corresponding to the speech data can be recognized based on the second speech feature carrying the accent feature, thereby improving the accuracy of the first speech text content, that is, improving the accuracy and the efficiency of speech recognition.

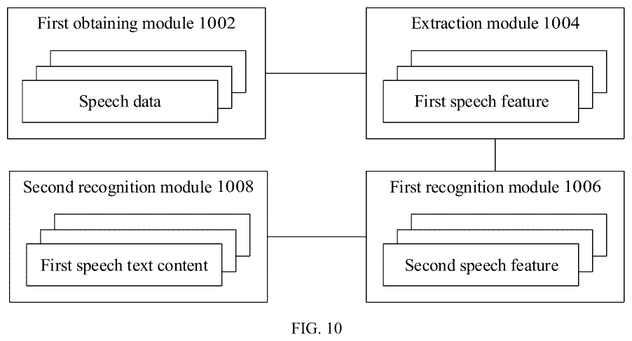

Corresponding to the above method embodiments, this specification further provides a speech recognition apparatus embodiment. FIG. 10 shows a schematic structural diagram of a speech recognition apparatus provided by an embodiment of this specification. As shown in FIG. 10, the apparatus includes:
a first obtaining module 1002, configured to obtain speech data to be recognized;
an extraction module 1004, configured to extract a speech feature in the speech data to obtain a first speech feature;
a first recognition module 1006, configured to perform accent feature recognition on the first speech feature to obtain a second speech feature carrying an accent feature; and
a second recognition module 1008, configured to recognize, based on the second speech feature, first speech text content corresponding to the speech data.

In an implementation, the apparatus further includes a second obtaining module, which is configured to:
obtain a pre-trained speech recognition model, where the speech recognition model includes an encoding layer, a multi-expert network layer and a decoding layer;
the extraction module 1004 is further configured to:
input the speech data into the encoding layer to extract the speech feature to obtain the first speech feature;
the first recognition module 1006 is further configured to:
input the first speech feature into the multi-expert network layer for accent feature recognition to obtain the second speech feature carrying the accent feature;
the second recognition module 1008 is further configured to:
input the second speech feature carrying the accent feature into the decoding layer to perform recognition on the speech data to obtain the first speech text content.

In an implementation, the apparatus further includes a training module, which is configured to:
obtain an accent speech training sample set and a preset to-be-trained model, where the accent speech training sample set contains multiple accent speech samples;
extract any accent speech sample from the multiple accent speech samples and input the accent speech sample into the to-be-trained model to obtain an output result; and
determine a loss value according to the output result, and adjust a model parameter of the to-be-trained model according to the loss value, continue to perform the step of extracting any accent speech sample from the multiple accent speech samples, and determine the to-be-trained model after training as the speech recognition model when a first preset training stop condition is met.

In an implementation, the apparatus further includes a correction module, which is configured to:
obtain an accent speech correction sample set, where the accent speech correction sample set contains multiple accent speech correction samples each carrying an accent speech label;
extract any accent speech correction sample from the accent speech correction sample set and input the accent speech correction sample into the speech recognition model to obtain a predicted recognition result;
determine a difference value according to the predicted recognition result and the accent speech label carried by the accent speech correction sample; and
adjust the model parameter of the speech recognition model according to the difference value, continue to perform the step of extracting any accent speech correction sample from the accent speech correction sample set, and obtain a target speech recognition model when a second preset training stop condition is met.

In an implementation, the to-be-trained model includes a sampling layer, an encoding layer, a multi-expert network layer and a decoding layer;
the training module is further configured to:
   input the accent speech sample into the sampling layer for sampling processing to obtain a sampling result for the accent speech sample;
   input the sampling result into the encoding layer for speech feature extraction to obtain a first predicted speech feature; and
   input the first predicted speech feature into the multi-expert network layer for accent feature recognition to obtain a second predicted speech feature carrying an accent feature;
determining the loss value according to the output result and adjusting the model parameter of the to-be-trained model according to the loss value includes:
   calculating the loss value according to the sampling result, the first predicted speech feature and the second predicted speech feature, and adjusting the model parameter of the to-be-trained model according to the loss value.

In an implementation, the training module is further configured to:
calculate a first sub-loss value according to the second predicted speech feature and the sampling result, and calculate a second sub-loss value according to the first predicted speech feature and the second predicted speech feature; and
adjust a first model parameter of the encoding layer based on the first sub-loss value, and adjust a second model parameter of the multi-expert network layer based on the second sub-loss value.

In an implementation, the training module is further configured to:
obtain an accent embedding feature of the accent speech sample; and
splice the accent embedding feature to the first predicted speech feature, input the first predicted speech feature spliced with the accent embedding feature into the multi-expert network layer for accent feature recognition to obtain the second predicted speech feature carrying the accent feature.

In an implementation, the training module is further configured to:
obtain an accent label of the accent speech sample;
input the accent label and the first predicted speech feature into the multi-expert network layer for accent feature recognition to obtain the second predicted speech feature carrying the accent feature;
determine a to-be-adjusted model parameter of the multi-expert network layer according to the accent label; and
adjust the to-be-adjusted model parameter based on the second sub-loss value.

In an implementation, the correction module is further configured to:
obtain an accent identifier of the accent speech correction sample;
input the accent speech correction sample into the encoding layer for speech feature extraction to obtain a third predicted speech feature;
input the third predicted speech feature and the accent identifier into the multi-expert network layer for accent feature recognition to obtain a fourth predicted speech feature carrying an accent feature; and
input the fourth predicted speech feature carrying the accent feature into the decoding layer to perform recognition to obtain the predicted recognition result.

In an implementation, the speech data is an audio segment of the audio to be recognized;
the second recognition module 1008 is further configured to:
obtain second speech text content of adjacent speech data, where the adjacent speech data is an audio segment adjacent to the speech data in the audio to be recognized; and
recognize the first speech text content corresponding to the speech data based on the second speech feature, the accent feature and the second speech text content.

In an implementation, the extraction module 1004 is further configured to:
perform sampling processing on the speech data to obtain a sampling result for the speech data; and
perform speech feature extraction on the sampling result for the speech data to obtain the first speech feature.

The speech recognition apparatus provided in an embodiment of this specification is configured to obtain speech data to be recognized; extract a speech feature in the speech data to obtain a first speech feature; perform accent feature recognition on the first speech feature to obtain a second speech feature carrying an accent feature; recognize, based on the second speech feature, first speech text content corresponding to the speech data. By performing the accent feature recognition on the first speech feature, the second speech feature carrying the accent feature can be obtained, and then during the speech text content recognition, the first speech text content corresponding to the speech data can be recognized based on the second speech feature carrying the accent feature, improving the accuracy of the first speech text content, that is, improving the accuracy and efficiency of speech recognition.

The above is a schematic scheme of a speech recognition apparatus of the embodiment. It should be noted that the technical solution of the speech recognition apparatus and the technical solution of the above-mentioned speech recognition method belong to the same concept. For details not described in detail in the technical solution of the speech recognition apparatus, reference can be made to the description of the technical solution of the above-mentioned speech recognition method.

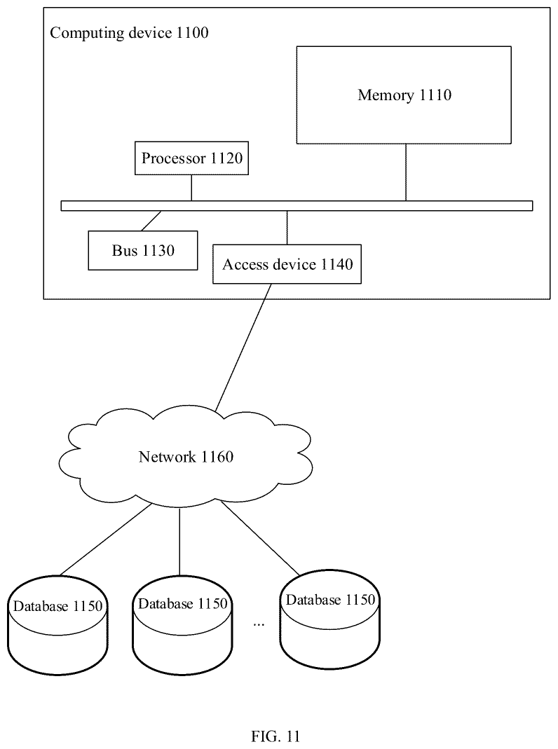

FIG. 11 shows a structural block diagram of a computing device 1100 provided by an embodiment of this specification. The components of the computing device 1100 include but are not limited to a memory 1110 and a processor 1120. The processor 1120 is connected to the memory 1110 via a bus 1130, and a database 1150 is used to store data.

The computing device 1100 further includes an access device 1140, which enables the computing device 1100 to communicate via one or more networks 1160. Examples of these networks include a Public Switched Telephone Network (PSTN), a Local Area Network (LAN), a Wide Area Network (WAN), a Personal Area Network (PAN), or a combination of communication networks such as the Internet. The access device 1140 may include one or more of any type of network interfaces (e.g., Network Interface Card (NIC)), wired or wireless, such as an IEEE802.11 Wireless Local Area Network (WLAN) wireless interface, a Worldwide Interoperability for Microwave Access (Wi-MAX) interface, an Ethernet interface, a Universal Serial Bus (USB) interface, a cellular network interface, a Bluetooth interface, a Near Field Communication (NFC) interface, and the like.

In an embodiment of the present specification, the above components of the computing device 1100 and other components not shown in FIG. 11 may also be connected to each other, for example, via a bus. It should be understood that the structural block diagram of the computing device shown in FIG. 11 is only for illustrative purpose and is not intended to limit the scope of this specification. Those skilled in the art can add or replace with other components as needed.

The computing device 1100 may be any type of stationary or mobile computing device, including a mobile computer or mobile computing device (e.g., a tablet computer, a personal digital assistant, a laptop computer, a notebook computer, a netbook, etc.), a mobile phone (e.g., a smart phone), a wearable computing device (e.g., a smart watch, smart glasses, etc.) or other types of mobile devices, or a stationary computing device such as a desktop computer or a PC. The computing device 1100 may also be a mobile or stationary server.

The processor 1120 is configured to execute the following computer-executable instructions, and when the computer-executable instructions are executed by the processor, the steps of the above-mentioned speech recognition method are implemented.

The above is a schematic scheme of a computing device of the embodiment. It should be noted that the technical solution of the computing device and the technical solution of the above-mentioned speech recognition method belong to the same concept. For details not described in detail in the technical solution of the computing device, reference can be made to the description of the technical solution of the above-mentioned speech recognition method.

An embodiment of this specification further provides a computer-readable storage medium storing computer-executable instructions, and when the computer-executable instructions are executed by a processor, the steps of the above-mentioned speech recognition method are implemented.

The above is a schematic scheme of a computer-readable storage medium of the embodiment. It should be noted that the technical solution of the storage medium and the technical solution of the above-mentioned speech recognition method belong to the same concept. For details not described in detail in the technical solution of the storage medium, reference can be made to the description of the technical solution of the above-mentioned speech recognition method.

An embodiment of this specification further provides a computer program, where when the computer program is executed in a computer, the computer is caused to perform the steps of the above-mentioned speech recognition method.

The above is a schematic scheme of a computer program of the embodiment. It should be noted that the technical solution of the computer program and the technical solution of the above-mentioned speech recognition method belong to the same concept. For details not described in detail in the technical solution of the computer program, reference can be made to the description of the technical solution of the above-mentioned speech recognition method.

The above describes specific embodiments of this specification. Other embodiments are within the scope of the appended claims. In some cases, the actions or steps recorded in the claims can be performed in an order different from that in the embodiments with the desired result still achieved. In addition, the process depicted in the figures does not necessarily require the specific order or continuous order shown to achieve the desired result. In some implementations, multitasking processing and parallel processing are also possible or may be advantageous.

The computer instructions include computer program codes, which may be in a form of source codes, object codes, executable file or some intermediate form. The computer-readable medium may include: any entity or apparatus capable of carrying the computer program codes, a recording medium, a U disk, a mobile hard disk, a magnetic disk, an optical disk, a computer memory, a Read-Only Memory (ROM), a Random Access Memory (RAM), an electric carrier signal, a telecommunication signal and a software distribution medium, etc.

It should be noted that for the aforementioned method embodiments, for the sake of simplicity, they are all described as a combination of series of actions, but those skilled in the art should know that the embodiments of this specification are not limited to the described action sequence. According to the embodiments of this specification, some steps can be performed in other sequences or simultaneously. Secondly, those skilled in the art should also know that the embodiments described in the specification are all preferred embodiments, and the actions and modules involved are not necessarily required by the embodiments of this specification.

In the above embodiments, the description of each embodiment has its own emphasis. For parts that are not described in detail in a certain embodiment, reference can be made to the relevant description of other embodiments.

The preferred embodiments of this specification disclosed above are only used to help explain this specification. The embodiments do not describe all the details in detail, nor do they limit the disclosure to the specific implementations described. Obviously, many modifications and changes can be made according to the content of the embodiments of this specification. This specification selects and describes these embodiments in detail in order to better explain the principles and practical applications of the embodiments of this specification, so that the skilled in the relevant art can well understand and use this specification. This specification is only limited by the claims and their full scope and equivalents.

1. A speech recognition method, comprising:
obtaining speech data to be recognized;
extracting a speech feature in the speech data to obtain a first speech feature;
performing accent feature recognition on the first speech feature to obtain a second speech feature carrying an accent feature; and
recognizing, based on the second speech feature, first speech text content corresponding to the speech data.

2. The method according to claim 1, wherein before extracting the speech feature in the speech data to obtain the first speech feature, the method further comprises:
obtaining a pre-trained speech recognition model, wherein the speech recognition model comprises an encoding layer, a multi-expert network layer, and a decoding layer wherein
extracting the speech feature in the speech data to obtain the first speech feature comprises: inputting the speech data into the encoding layer to extract the speech feature to obtain the first speech feature,
performing the accent feature recognition on the first speech feature to obtain the second speech feature carrying the accent feature comprises: inputting the first speech feature into the multi-expert network layer for the accent feature recognition to obtain the second speech feature carrying the accent feature, and
recognizing, based on the second speech feature, the first speech text content corresponding to the speech data comprises: inputting the second speech feature carrying the accent feature into the decoding layer to perform recognition on the speech data to obtain the first speech text content.

3. The method according to claim 2, wherein before obtaining the pre-trained speech recognition model, the method further comprises:
obtaining an accent speech training sample set and a preset to-be-trained model, wherein the accent speech training sample set contains multiple accent speech samples;
extracting any accent speech sample from the multiple accent speech samples and inputting the accent speech sample into the to-be-trained model to obtain an output result; and
determining a loss value according to the output result, and adjusting a model parameter of the to-be-trained model according to the loss value, continuing to perform the step of extracting any accent speech sample from the multiple accent speech samples, and determining the to-be-trained model after training as the speech recognition model when a first preset training stop condition is met.

4. The method according to claim 3, wherein after determining the to-be-trained model after training as the speech recognition model when the first preset training stop condition is met, the method further comprises:
obtaining an accent speech correction sample set, wherein the accent speech correction sample set contains multiple accent speech correction samples each carrying an accent speech label;
extracting any accent speech correction sample from the accent speech correction sample set and inputting the accent speech correction sample into the speech recognition model to obtain a predicted recognition result;
determining a difference value according to the predicted recognition result and the accent speech label carried by the accent speech correction sample; and
adjusting the model parameter of the speech recognition model according to the difference value, continuing to perform the step of extracting any accent speech correction sample from the accent speech correction sample set, and obtaining a target speech recognition model when a second preset training stop condition is met.

5. The method according to claim 3, wherein the to-be-trained model comprises a sampling layer, an encoding layer, a multi-expert network layer, and a decoding layer;
inputting the accent speech sample into the to-be-trained model to obtain the output result comprises:
inputting the accent speech sample into the sampling layer for sampling processing to obtain a sampling result for the accent speech sample;
inputting the sampling result into the encoding layer for speech feature extraction to obtain a first predicted speech feature; and
inputting the first predicted speech feature into the multi-expert network layer for accent feature recognition to obtain a second predicted speech feature carrying an accent feature;
determining the loss value according to the output result, and adjusting the model parameter of the to-be-trained model according to the loss value comprises:
calculating the loss value according to the sampling result, the first predicted speech feature and the second predicted speech feature and adjusting the model parameter of the to-be-trained model according to the loss value.

6. The method according to claim 5, wherein calculating the loss value according to the sampling result, the first predicted speech feature and the second predicted speech feature and adjusting the model parameter of the to-be-trained model according to the loss value comprises:
calculating a first sub-loss value according to the second predicted speech feature and the sampling result, and calculating a second sub-loss value according to the first predicted speech feature and the second predicted speech feature; and
adjusting a first model parameter of the encoding layer based on the first sub-loss value, and adjusting a second model parameter of the multi-expert network layer based on the second sub-loss value.

7. The method according to claim 5, wherein before inputting the first predicted speech feature into the multi-expert network layer for accent feature recognition to obtain the second predicted speech feature carrying the accent feature, the method further comprises:
obtaining an accent embedding feature of the accent speech sample, wherein
inputting the first predicted speech feature into the multi-expert network layer for accent feature recognition to obtain the second predicted speech feature carrying the accent feature comprises: splicing the accent embedding feature to the first predicted speech feature, inputting the first predicted speech feature spliced with the accent embedding feature into the multi-expert network layer for accent feature recognition to obtain the second predicted speech feature carrying the accent feature.

8. The method according to claim 6, wherein before inputting the first predicted speech feature into the multi-expert network layer for accent feature recognition to obtain the second predicted speech feature carrying the accent feature, the method further comprises:
obtaining an accent label of the accent speech sample;
inputting the first predicted speech feature into the multi-expert network layer for accent feature recognition to obtain the second predicted speech feature carrying the accent feature comprises:
inputting the accent label and the first predicted speech feature into the multi-expert network layer for accent feature recognition to obtain the second predicted speech feature carrying the accent feature;
adjusting the second model parameter of the multi-expert network layer based on the second sub-loss value comprises:
determining a to-be-adjusted model parameter of the multi-expert network layer according to the accent label; and
adjusting the to-be-adjusted model parameter based on the second sub-loss value.

9. The method according to claim 4, wherein inputting the accent speech correction sample into the speech recognition model to obtain the predicted recognition result comprises:
obtaining an accent identifier of the accent speech correction sample;
inputting the accent speech correction sample into the encoding layer for speech feature extraction to obtain a third predicted speech feature;
inputting the third predicted speech feature and the accent identifier into the multi-expert network layer for accent feature recognition to obtain a fourth predicted speech feature carrying an accent feature; and
inputting the fourth predicted speech feature carrying the accent feature into the decoding layer to perform recognition to obtain the predicted recognition result.

10. The method according to claim 1, wherein the speech data is an audio segment of an audio to be recognized;
recognizing, based on the second speech feature, the first speech text content corresponding to the speech data comprises:
obtaining second speech text content of adjacent speech data, wherein the adjacent speech data is an audio segment adjacent to the speech data in the audio to be recognized; and
recognizing the first speech text content corresponding to the speech data according to the second speech feature, the accent feature and the second speech text content.

11. The method according to claim 1, wherein extracting the speech feature in the speech data to obtain the first speech feature comprises:
performing sampling processing on the speech data to obtain a sampling result for the speech data; and
performing speech feature extraction on the sampling result for the speech data to obtain the first speech feature.

12. (canceled)

13. A computing device, comprising:
a memory and a processor;
wherein the memory is configured to store computer-executable instructions, and the processor is configured to execute the computer-executable instructions to:
obtain speech data to be recognized;
extract a speech feature in the speech data to obtain a first speech feature;
perform accent feature recognition on the first speech feature to obtain a second speech feature carrying an accent feature; and
recognize, based on the second speech feature, first speech text content corresponding to the speech data.

14. A non-transitory computer-readable storage medium storing computer-executable instructions, wherein the computer-executable instructions are executed by a processor to:
obtain speech data to be recognized;
extract a speech feature in the speech data to obtain a first speech feature;
perform accent feature recognition on the first speech feature to obtain a second speech feature carrying an accent feature; and
recognize, based on the second speech feature, first speech text content corresponding to the speech data.

15. The method according to claim 6, wherein before inputting the first predicted speech feature into the multi-expert network layer for accent feature recognition to obtain the second predicted speech feature carrying the accent feature, the method further comprises:
obtaining an accent embedding feature of the accent speech sample, wherein
inputting the first predicted speech feature into the multi-expert network layer for accent feature recognition to obtain the second predicted speech feature carrying the accent feature comprises: splicing the accent embedding feature to the first predicted speech feature, inputting the first predicted speech feature spliced with the accent embedding feature into the multi-expert network layer for accent feature recognition to obtain the second predicted speech feature carrying the accent feature.

16. The method according to claim 10, wherein extracting the speech feature in the speech data to obtain the first speech feature comprises:
performing sampling processing on the speech data to obtain a sampling result for the speech data; and
performing speech feature extraction on the sampling result for the speech data to obtain the first speech feature.

17. The computing device according to claim 13, wherein the processor is configured to execute the computer-executable instructions to:
obtain a pre-trained speech recognition model, wherein the speech recognition model comprises an encoding layer, a multi-expert network layer, and a decoding layer;
input the speech data into the encoding layer to extract the speech feature to obtain the first speech feature;
input the first speech feature into the multi-expert network layer for the accent feature recognition to obtain the second speech feature carrying the accent feature; and
input the second speech feature carrying the accent feature into the decoding layer to perform recognition on the speech data to obtain the first speech text content.

18. The computing device according to claim 17, wherein the processor is configured to execute the computer-executable instructions to:
obtain an accent speech training sample set and a preset to-be-trained model, wherein the accent speech training sample set contains multiple accent speech samples;
extract any accent speech sample from the multiple accent speech samples and input the accent speech sample into the to-be-trained model to obtain an output result; and
determine a loss value according to the output result, and adjust a model parameter of the to-be-trained model according to the loss value, continue to perform the step of extracting any accent speech sample from the multiple accent speech samples, and determine the to-be-trained model after training as the speech recognition model when a first preset training stop condition is met.

19. The computing device according to claim 18, wherein the processor is configured to execute the computer-executable instructions to:
obtain an accent speech correction sample set, wherein the accent speech correction sample set contains multiple accent speech correction samples each carrying an accent speech label;
extract any accent speech correction sample from the accent speech correction sample set and input the accent speech correction sample into the speech recognition model to obtain a predicted recognition result;
determine a difference value according to the predicted recognition result and the accent speech label carried by the accent speech correction sample; and
adjust the model parameter of the speech recognition model according to the difference value, continue to perform the step of extracting any accent speech correction sample from the accent speech correction sample set, and obtain a target speech recognition model when a second preset training stop condition is met.

20. The computing device according to claim 18, wherein the to-be-trained model comprises a sampling layer, an encoding layer, a multi-expert network layer, and a decoding layer, and the processor is configured to execute the computer-executable instructions to:
input the accent speech sample into the sampling layer for sampling processing to obtain a sampling result for the accent speech sample;
input the sampling result into the encoding layer for speech feature extraction to obtain a first predicted speech feature;
input the first predicted speech feature into the multi-expert network layer for accent feature recognition to obtain a second predicted speech feature carrying an accent feature; and
calculate the loss value according to the sampling result, the first predicted speech feature and the second predicted speech feature and adjust the model parameter of the to-be-trained model according to the loss value.

21. The computing device according to claim 20, wherein the processor is configured to execute the computer-executable instructions to:
calculate a first sub-loss value according to the second predicted speech feature and the sampling result, and calculate a second sub-loss value according to the first predicted speech feature and the second predicted speech feature; and
adjust a first model parameter of the encoding layer based on the first sub-loss value, and adjust a second model parameter of the multi-expert network layer based on the second sub-loss value.
